(19) United States
(12) Patent Application Publication
(10) Pub. No.: US 2023/0191611 A1
(43) Pub. Date: Jun. 22, 2023

(54) ROBOT SYSTEM

(71) Applicant: FANUC CORPORATION, Yamanashi (JP)

(72) Inventors: Yuelai WANG, Yamanashi (JP); Yasuhiro NAITOU, Yamanashi (JP)

(73) Assignee: FANUC CORPORATION, Yamanashi (JP)

(21) Appl. No.: 17/758,863

(22) PCT Filed: Feb. 22, 2021
(86) PCT No.: PCT/JP2021/006630

§ 371 Date: Jan. 20, 2023

(30) Foreign Application Priority Data
Feb. 25, 2020 (JP) 2020-029503

(51) Int. Cl. B25J 9/16; B25J 13/08

(52) U.S. Cl. CPC B25J 9/1692; B25J 9/1607; B25J 13/089

(57) ABSTRACT

Provided is a robot system in which when a robot is transported to and installed at an actual installation position, correction is made to correct errors in robot installation. This robot system is provided with: a reference point disposed at a location where a robot is to be installed; a position measurement means that, at a plurality of positions to which the robot is moved, makes a measurement of a prescribed position of the robot according to an installation coordinate system C1 based on the reference point; a position calculation means that determines a prescribed position of the robot according to a base coordinate system C2 of the robot; and a matrix calculation means that calculates a conversion matrix used to convert the base coordinate system C2 to the installation coordinate system C1 so that any difference between the prescribed position measured by the position measurement means and the prescribed position determined by the position calculation means becomes minimal.

### TECHNICAL FIELD

The present invention relates to a robot system.

### BACKGROUND ART

Conventionally, the operation of a robot at an actual installation location is set by offline teaching in which the movement path of the robot is created on software and the motion of the robot is learned, and thereby the time required for setting the robot at the actual installation location is reduced (for example, see Patent Document 1). Patent Document 1 discloses a technique for improving the absolute accuracy of the tip of a multi-joint robot by identifying a plurality of mechanical error parameters such that the difference between measured position information obtained by measuring the position information of the tip in a plurality of postures of the robot using a 3D position measuring instrument and a theoretical position of the tip obtained by performing calculation of forward kinematics (forward transformation) from angle data of each rotational joint and lengths of links is minimized.

### PRIOR ART REFERENCE

### Patent Document

Patent Document 1: Japanese Unexamined Patent Application, Publication No. 2012-196716

### DISCLOSURE OF THE INVENTION

### Problems to be Solved by the Invention

However, in the above-described technology, when the robot is transported to and installed at an actual installation location, due to an installation error caused by deviation from an installation reference, inclination of an installation plane, or the like, a problem such as interference between a workpiece and the robot may occur when a motion program created by offline teaching is operated.

In response to the above issue, it is an object of the present invention to provide a robot system that corrects for an installation error of a robot when the robot is transported to and installed at an actual installation location.

### Means for Solving the Problems

An aspect of the present disclosure provides a robot system. The robot system includes a reference point provided at a location where a robot is provided, a position measuring instrument that measures a predetermined position of the robot in an installation coordinate system based on the reference point, at each of a plurality of positions to which the robot is moved, a position calculator that obtains the predetermined position in a base coordinate system of the robot, and a matrix calculator that calculates a conversion matrix for converting the base coordinate system into the installation coordinate system so that a difference between the predetermined position measured by the position measuring instrument and the predetermined position obtained by the position calculator is minimized.

### Effects of the Invention

According to the aspect of the present disclosure, it is possible to correct for an installation error of a robot when the robot is transported to and installed at an actual installation location.

### BRIEF DESCRIPTION OF THE DRAWINGS

FIG. 1 is a schematic view of a robot system according to an embodiment, showing a state before a robot is installed;

FIG. 2 is a schematic view of the robot system shown in FIG. 1, showing a state after the robot is installed;

FIG. 3 is a functional block diagram of a control device included by the robot system shown in FIG. 1; and

FIG. 4 is a flowchart showing the operation of the robot system shown in FIG. 1.

### PREFERRED MODE FOR CARRYING OUT THE INVENTION

Hereinafter, a robot system 1 according to an embodiment will be described with reference to the drawings.

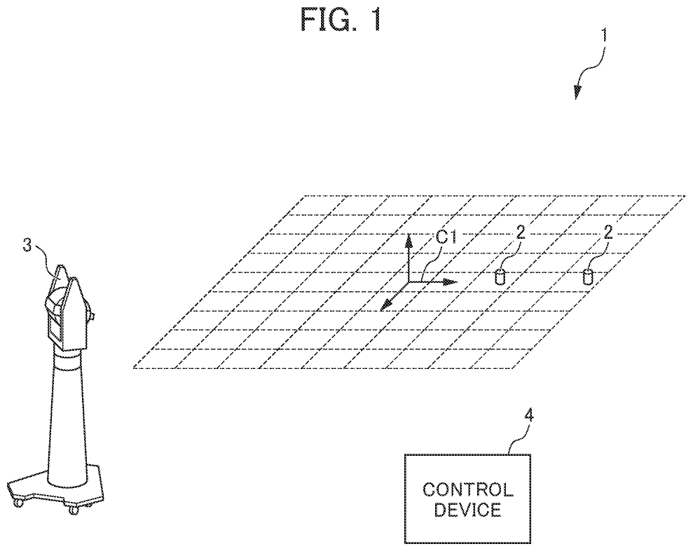

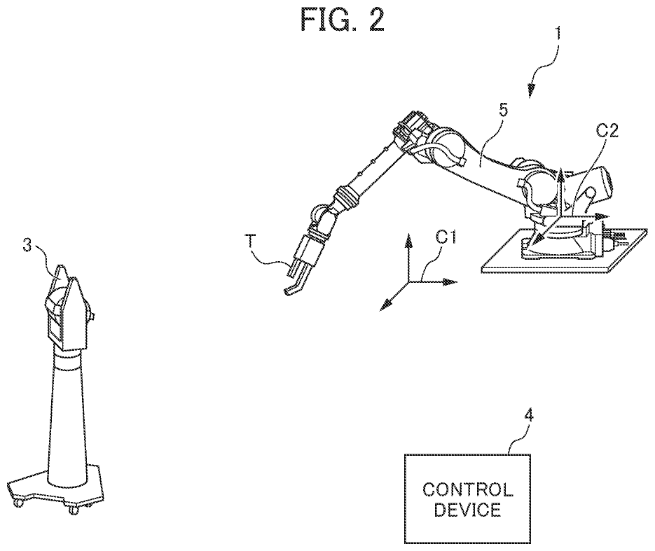

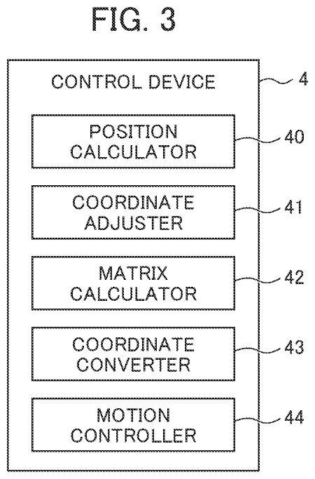

First, the configuration of the robot system 1 will be described with reference to FIGS. 1 to 3. FIG. 1 is a schematic view of the robot system 1 showing a state before a robot 5 is installed. FIG. 2 is a schematic view of the robot system 1 showing a state after the robot 5 is installed. FIG. 3 is a block diagram of a control device 4 included by the robot system 1.

In the robot system 1 shown in FIGS. 1 and 2, for example, a tool T and a workpiece (not shown) are relatively moved by using the robot 5, whereby the workpiece (not shown) is processed by the tool T. Specifically, the robot system 1 includes a reference point 2, a 3D measuring instrument 3, the control device 4, and the robot 5.

The reference point 2 is one or more points provided at a location where the robot 5 is installed, and is optionally set. As the reference point 2, for example, a positioning pin for positioning the robot 5 can be employed.

The 3D measuring instrument 3 measures the position in an installation coordinate system C1 based on the reference point 2. The installation coordinate system C1 is an ideal coordinate system set at an actual installation location of the robot 5. The 3D measuring instrument 3 measures a predetermined position (for example, the position of the tip) of the robot 5 in the installation coordinate system C1 based on the reference point 2. The 3D measuring instrument 3 is fixed to a location where the predetermined position of the robot 5 can be measured (that is, a location near a location where the robot 5 is installed).

As the 3D measuring instrument 3, for example, a laser tracker can be used, and in this case, measurement is performed by arranging a reflector at the position of the tip of the robot 5. The reflector may be arranged at an approximate position, but by arranging the reflector at an ideal tool center point (TCP) position of the robot 5 using a precision jig, it is possible to identify an accurate installation error that does not include a TCP error of the robot 5.

In the measurement performed by the 3D measuring instrument 3, a motion controller 44, which will be described later, moves the robot 5 to a plurality of positions, and the predetermined position of the robot 5 is measured at each of the positions. For example, the robot 5 is moved to a minimum of six positions corresponding to six axes of the X-axis, the Y-axis, the Z-axis, the W-axis, the P-axis, and the R-axis of the robot 5, and the predetermined position of the robot 5 at each of the positions is measured. As the number of measurement points increases, it is possible to accurately correct for the deviation of an installation error of the robot 5. The number of measurement points is more preferably 10 or more.

The control device 4 stores programs, teaching data, and the like, related to control at the time of installation and motion of the robot 5. The control device 4 realizes various functions of a position calculator 40, a coordinate adjuster 41, a matrix calculator 42, a coordinate converter 43, a motion controller 44, and so on by executing a program.

The position calculator 40 functions as a position calculation means that obtains the predetermined position (e.g., the position of the tip) of the robot 5 in the original base coordinate system C2 of the robot 5.

The coordinate adjuster 41 functions as a coordinate adjustment means that adjusts the original coordinate system of the 3D measuring instrument 3 to the installation coordinate system C1 based on the reference point 2 from the relative positional relationship between the coordinate system of the 3D measuring instrument 3 and the installation coordinate system C1 based on the reference point 2.

The matrix calculator 42 functions as a matrix calculation means that calculates a conversion matrix (e.g., a Jacobian matrix) for converting the base coordinate system C2 of the robot 5 into the installation coordinate system C1 based on the reference point 2 by using a least squares method so that the difference between the predetermined position of the robot 5 measured by the 3D measuring instrument 3 and the predetermined position of the robot 5 obtained by the position calculator 40 is minimized.

The coordinate converter 43 functions as a coordinate conversion means that converts the base coordinate system C2 of the robot 5 into the installation coordinate system C1 based on the reference point 2 using the conversion matrix calculated by the matrix calculator 42.

The motion controller 44 functions as a motion control means that operates the robot 5 in the installation coordinate system C1 converted by the coordinate converter 43.

The robot 5 is, for example, of a multi-joint type such as a six-axis vertical multi-joint type or a four-axis vertical multi-joint type, and the tool T is attached to the tip of the robot 5.

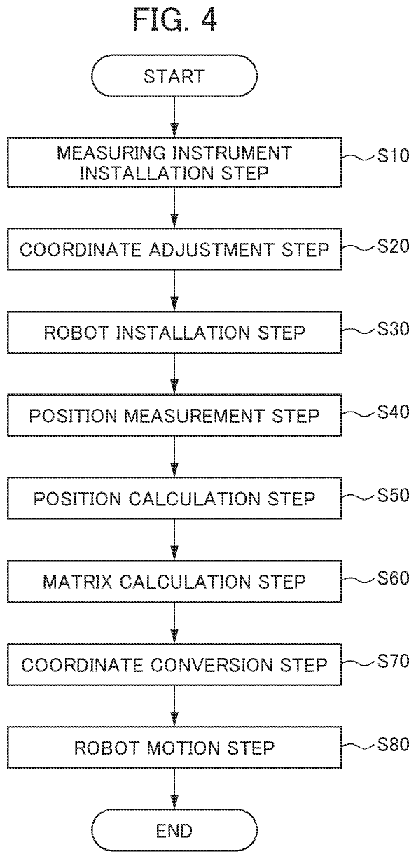

With reference to FIG. 4, the operation of the robot system 1 will be described. FIG. 4 is a flowchart showing the operation of the robot system 1.

As shown in FIG. 4, the robot system 1 includes, as operation steps, a measuring instrument installation step S10, a coordinate adjustment step S20, a robot installation step S30, a position measurement step S40, a position calculation step S50, a matrix calculation step S60, a coordinate conversion step S70, and a robot motion step S80.

In the measuring instrument installation step S10, the 3D measuring instrument 3 is installed at a location where the predetermined position of the robot 5 can be measured (that is, a location near a location where the robot 5 is installed).

In the coordinate adjustment step S20, the coordinate adjuster 41 of the control device 4 functions as a coordinate adjustment means, whereby the original coordinate system of the 3D measuring instrument 3 is adjusted to the installation coordinate system C1 based on the reference point 2 from the relative positional relationship between the coordinate system of the 3D measuring instrument 3 and the installation coordinate system C1 based on the reference point 2.

In the robot installation step S30, the robot 5 is installed at a location where the predetermined position of the robot 5 can be measured by the 3D measuring instrument 3 (that is, a location near the location where the 3D measuring instrument 3 is installed).

In the position measurement step S40, the 3D measuring instrument 3 measures the predetermined position of the robot 5 in the installation coordinate system C1 based on the reference point 2, and the measurement result is input from the 3D measuring instrument 3 to the matrix calculator 42 of the control device 4. The motion controller 44 moves the robot 5 to a plurality of positions, and the 3D measuring instrument 3 performs measurement at each of the positions after the movement.

In the position calculation step S50, the position calculator 40 of the control device 4 functions as a position calculation means, whereby the predetermined position of the robot 5 in the original base coordinate system C2 of the robot 5 is obtained, and the obtained result is input from the position calculator 40 to the matrix calculator 42.

In the matrix calculation step S60, the matrix calculator 42 of the control device 4 functions as a matrix calculation means, whereby a conversion matrix for converting the base coordinate system C2 of the robot 5 into the installation coordinate system C1 based on the reference point 2 is calculated by using a least squares method so that the difference between the predetermined position of the robot 5 measured by the 3D measuring instrument 3 and the predetermined position of the robot 5 obtained by the position calculator 40 is minimized, and the calculated result is input from the matrix calculator 42 to the coordinate converter 43.

In the coordinate conversion step S70, the coordinate converter 43 of the control device 4 functions as a coordinate conversion means, whereby the base coordinate system C2 of the robot 5 is converted into the installation coordinate system C1 based on the reference point 2 using the conversion matrix calculated by the matrix calculator 42, and the conversion result is input from the coordinate converter 43 to the motion controller 44.

In the robot motion step S80, the motion controller 44 of the control device 4 functions as a motion control means, whereby the robot 5 is operated in the installation coordinate system C1 converted by the coordinate converter 43.

As described above, the robot system 1 includes the reference point 2 provided at the location where the robot 5 is installed, the 3D measuring instrument 3 that measures the predetermined position of the robot 5 in the installation coordinate system C1 based on the reference point 2, at each of the plurality of positions to which the robot is moved, the position calculator 40 that obtains the predetermined position of the robot 5 in the base coordinate system C2 of the robot 5, and the matrix calculator 42 that calculates the conversion matrix for converting the base coordinate system C2 into the installation coordinate system C1 so that the difference between the predetermined position of the robot 5 measured by the 3D measuring instrument 3 and the predetermined position of the robot 5 obtained by the position calculator 40 is minimized.

In the robot system 1, the position measuring means that measures the predetermined position of the robot 5 in the installation coordinate system C1 based on the reference point 2 is preferably the 3D measuring instrument 3.

The robot system 1 preferably includes a coordinate converter 43 that converts the base coordinate system C2 into the installation coordinate system C1 using the conversion matrix calculated by the matrix calculator 42, and the motion controller 44 that operates the robot 5 in the installation coordinate system C1 converted by the coordinate converter 43.

As described above, according to the robot system 1, it is possible to correct for an installation error of the robot 5 when the robot 5 is transported to and installed at an actual installation location. Accordingly, it is possible to avoid occurrence of a problem such as interference between the workpiece and the robot when a motion program created by offline teaching is operated. Consequently, the machining accuracy can be improved.

The present invention is not limited to the above-described embodiment, and modifications and improvements within a range where the object of the present invention can be achieved are included in the present invention.

Although the robot system 1 includes the 3D measuring instrument 3 as a position measuring means that measures the predetermined position of the robot 5 in the installation coordinate system C1 based on the reference point 2, for example, a 2D measuring instrument such as a camera may be included instead of the 3D measuring instrument 3.

### EXPLANATION OF REFERENCE NUMERALS

1 robot system
2 reference point
3 3D measuring instrument (position measuring means)
4 control device
40 position calculator (position calculation means)
41 coordinate adjuster
42 matrix calculator (matrix calculation means)
43 coordinate converter (coordinate conversion means)
44 motion controller (motion control means)
5 robot
T tool
C1 installation coordinate system
C2 base coordinate system
S10 measuring instrument installation step
S20 coordinate adjustment step
S30 robot installation step
S40 position measurement step
S50 position calculation step
S60 matrix calculation step
S70 coordinate conversion step
S80 robot motion step

1. A robot system, comprising:
a reference point provided at a location where a robot is provided;
a position measuring instrument that measures a predetermined position of the robot in an installation coordinate system based on the reference point, at each of a plurality of positions to which the robot is moved;
a position calculator that obtains the predetermined position in a base coordinate system of the robot; and
a matrix calculator that calculates a conversion matrix for converting the base coordinate system into the installation coordinate system so that a difference between the predetermined position measured by the position measuring instrument and the predetermined position obtained by the position calculator is minimized.

2. The robot system according to claim 1, wherein the position measuring instrument is a 3D measuring instrument.

3. The robot system according to claim 1, comprising:
a coordinate converter that converts the base coordinate system into the installation coordinate system using the conversion matrix calculated by the matrix calculator; and
a motion controller that operates the robot in the installation coordinate system converted by the coordinate converter.
